(19) United States
(12) Patent Application Publication
(10) Pub. No.: US 2007/0295559 A1
(43) Pub. Date: Dec. 27, 2007

(54) Modular energy amplification and transfer system

(76) Inventor: Edward J. Schliep, East Bethel, MN (US)

Correspondence Address: DOUGLAS L. TSCHIDA, 633 LARPENTEUR AVE. WEST, SUITE B, ST. PAUL, MN, 55113, US

(21) Appl. No.: 11/809,626

(22) Filed: May 31, 2007

Related U.S. Application Data
(60) Provisional application No. 60/809,603, filed on May 31, 2006.

(51) Int. Cl. F03G 3/00

(52) U.S. Cl. 185/33

(57) ABSTRACT

A power amplification and transfer assembly and alternative multi-stage systems wherein power is transferred to the outer periphery of included flywheels via included drive frames and lever arms. One power transfer assembly comprises an elongated framework that rotationally supports a drive frame, a pair of flywheel frames and a spring biased, resilient, flexible lever arm assembly. The drive frame, flywheels and lever arm assemblies are mounted to independent axles. Couplers at the drive frame and lever arm assemblies are secured to the outer circumference of the flywheel(s). System input power is provided from a gas/diesel engine and chain/sprocket linkage or a powered hydraulic engine and pump that increase the rpm's to the power amplification assembly. Successive amplification stages are coupled together with powered or un-powered couplers (e.g. hydraulic pump/engine, wind turbine). Alternative, flexibly resilient lever arm assemblies provide several arms mounted to fulcrum pins at a central axle to permit a freedom of movement to each arm. In one construction the arms are secured to each other at an oversized groove. Springs or other resilient devices bias the lever arms to compensate for assembly vibration and enhance power upon centrifugally releasing stored energy from the resilient bias device.

### RELATED APPLICATIONS

This is a non-provisional application of provisional application Ser. No. 60/809,603, filed May 31, 2006.

### FIELD OF THE INVENTION

The present invention relates to power transfer apparatus and in particular to a system having an input power source (e.g. gas/diesel/petrochemical or hydraulic engine) that drives modular, interconnected frame assemblies and wherein each frame assembly includes a rotating drive frame, one or more flywheel(s) and an output lever-type frame/arm assembly that rotate within a supporting framework.

### BACKGROUND OF THE INVENTION

The invention relates to a power transfer assembly and modular systems that amplify or multiply the torque of an input power source such as provided from a gas/diesel engine or powered hydraulic input device. A variety of such devices and systems have been developed. Each requires a fuel source to maintain operation and the output power is determined by the type of fuel and operating efficiency of the power transfer train.

A variety of torque transfer assemblies have also been developed for use with conventional engines, motors and the like to transfer power in a system. Such devices typically employ gears, sprockets and chains, belts and pulleys to variously step-up or step-down the rotation of associated drive shafts to suitably transfer power to a load. Flywheels and hydraulic torque converters have also been incorporated into such power transfer systems to store power and assist in speed regulation.

The desirability of any system or assembly is frequently dictated by fuel availability and economies, size and weight restrictions and other considerations peculiar to each application.

Applicant is unaware of any flywheel system that uses a frame constructed flywheel assembly wherein the mechanical advantage of lever arms is used in conjunction with a flywheel to enhance the throughput and output power. The present invention provides a flywheel-based power amplification assembly to multiply the power provided by an input power source. The enhanced power is used in a system to drive similar successive amplification stages to further elevate the power to drive loads requiring the enhanced power levels. Supplemental power sources are appropriately included to add power to the system to overcome losses.

### SUMMARY OF THE INVENTION

It is a primary object of the present invention to provide a power transfer and amplification assembly and system wherein the power of an input power source is amplified via a flywheel based assembly and a lever arm coupling to the flywheel displaced from a supporting, powered axle.

It is a further object of the invention to provide a power transfer and amplification assembly wherein an input power source is coupled to a rotating lever arm linkage that transfers power to the circumference of a flywheel based assembly displaced from the powered input lever arm linkage and a supporting axle.

It is a further object of the invention to provide a power transfer and amplification assembly wherein power is transferred from a rotating flywheel assembly via a rotationally mounted lever arm linkage that transfers power to an output device.

It is a further object of the invention to include a step-up coupler between an input power source and the power amplification assembly.

It is a further object of the invention to use input power obtained from gas/diesel/petrochemical engines, hydraulic assemblies (e.g. a switched pump/engine), pneumatic assemblies, wind, hydro, steam, biomass, solar, electric, or other power sources.

It is a further object of the invention to provide a system including several power amplification assemblies coupled together in stages and/or in combination with intermediate supplemental power sources, such as obtained from a hydraulic pump/engines or a wind turbine to compensate for system losses.

It is a further object of the invention to provide a power amplification assembly comprised of several frame constructed, rotationally mounted flywheels mounted to receive and transfer power from and to rotationally mounted lever arm coupler assemblies.

It is a further object of the invention to provide a power amplification assembly comprised of a drive frame independently mounted to a powered axle and secured to the outer circumference of one or more displaced, independently mounted flywheel(s).

It is a further object of the invention to provide a power amplification assembly comprised of a lever arm assembly independently mounted to a stub axle and secured to the outer circumference of one or more displaced, independently mounted flywheel(s).

It is a further object of the invention to provide a power amplification assembly comprised of a frame constructed lever arm assembly independently mounted to a stub axle and secured to the outer circumference of one or more displaced, independently mounted flywheel(s).

It is a further object of the invention to provide a lever arm assembly constructed to provide a resilient, flexible mounting between a rotating flywheel and an associated stub axle to compensate for system vibration.

It is a further object of the invention to provide a lever arm assembly including a spring biased mounting that centrifugally enhances the power amplification forces and throughput power.

It is a further object of the invention to provide a power amplification assembly comprised of a resilient, flexible frame constructed lever arm assembly mounted to a stub axle and secured to the outer circumference of one or more flywheel(s) via to compensate for system vibration.

It is a further object of the invention to provide a rotational lever arm assembly wherein several arms radiate from a supporting axle and wherein each arm is mounted with a freedom of movement with centrifugal motion.

It is a further object of the invention to provide a rotational lever arm assembly wherein several arms radiate from a supporting axle and wherein each arm is spring biased and mounted to pivot slightly with centrifugal motion.

The foregoing objects are achieved in a presently preferred power transfer system wherein a source of input power is supplied to a

In one system construction, a gas engine is used as the input power source. Other system constructions contemplate the use of hydraulic and/or wind power inputs alone or in combination with one or several power amplification assemblies. Power is supplied from the engine via a centrifugal clutch linkage and jack shaft assembly that increase the rpm's to a frame configured power conversion/amplification, transfer assembly.

The power transfer assembly comprises an elongated octagonal framework that includes a rotationally mounted drive frame, a pair of rotationally mounted flywheel frames and a rotationally mounted, resilient, flexible lever arm assembly. The drive frame and lever arm assemblies are mounted to independent input and output stub shaft axles. Couplers at the drive frame and lever arm assemblies are secured to the outer circumference of the flywheel(s) which rotate about an independent axle secured to the framework. The input torque power is amplified at the amplification assembly via the lever arm advantage gained at the drive frame and lever arms.

The output power of the first stage is coupled via a controlled hydraulic pump/engine to a second identical stage where it is amplified by additional drive frame and lever arm assemblies that cooperate with associated flywheel(s). The output power of the second stage can in turn be magnified at a third identical amplification stage which can be coupled to the second stage with a similar hydraulic engine/pump or a wind turbine. Supplemental power can be added at each of the stage couplings to compensate for system losses.

In another system construction, power is supplied to a lever arm amplification assembly from a gas/diesel engine driven hydraulic pump/engine. The first stage output power is coupled to a hydraulic pump/engine that in turn drives a second amplification stage to further amplify the system power throughput. Additional stages can be added as desired and be supplied with supplemental power as necessary. The same or combinations of different active (i.e. powered) or passive coupler assemblies can couple the successive stages.

Alternative flexibly resilient lever arm assemblies are also disclosed at the power amplification assembly. In one construction, several arms radiate from a central axle. Each arm is mounted to a fulcrum pin at a central axle and to an adjacent arm at an oversized groove to permit a freedom of movement to each arm. Springs or other resilient devices (e.g. elastomer or compressive/expansive devices) bias the lever arms to compensate for assembly vibration and enhance power upon centrifugally releasing stored energy from the resilient bias device.

In another lever arm construction, several arms are radiate from a central axle to a circumscribing frame. Each arm is mounted to a fulcrum pin at a central axle and to an oversized fastening to a coupler to permit a freedom of movement to each arm. Springs or other resilient devices bias the lever arms to compensate for assembly vibration and enhance power upon centrifugally releasing stored energy from the resilient bias device.

Still other objects, advantages and constructions of the present invention, among various considered improvements and modifications, will become apparent from the detailed description provided hereinafter. It should be understood that the detailed description and specific examples, while indicating a presently preferred embodiment of the invention, are intended for purposes of illustration only and are not intended to limit the scope of the invention.

### BRIEF DESCRIPTION OF THE DRAWINGS

FIG. 1 is a block diagram demonstrating a variety of modular power amplification systems that can be constructed using the assemblies of the invention.

FIG. 2 shows a perspective view in partial cutaway of one multi-stage system assembly and interconnected power amplification frames.

FIG. 3 shows a generalized plan view of a system comprised of several interconnected power conversion/amplification assemblies in relation to several alternative input and supplemental power sources and which power sources can be adapted in any variety of combinations with the amplification assemblies 14.

FIG. 4 shows a perspective view of the jack shaft assembly.

FIG. 5 shows a plan view to end and intermediate frame sections of the amplification assembly.

FIG. 6 shows a plan view to a drive frame.

FIG. 7 shows a plan view to a flywheel frame.

FIG. 8 shows a perspective view to the flexible, resiliently biased lever arm assembly used to couple the output flywheel to the output stub axle shaft.

FIG. 9 shows a plan view to a lever arm assembly with the cover plate and output stub axle shaft removed.

FIG. 10 shows a diagram of measured power output of a single amplification/conversion assembly.

FIG. 11 shows a plan view to an alternative lever arm frame.

FIG. 12 shows an alternative generalized plan view of a system comprised of several interconnected power conversion/amplification assemblies in relation to a gas/diesel engine driven hydraulic pump/engine input power source, a hydraulic pump/engine second stage coupler and a third stage wind powered supplemental power source can be adapted in any variety of combinations with the amplification assemblies 14.

The present invention will become more fully understood from the detailed description and the accompanying drawings, wherein similar reference callouts are used at the various figures, and wherein:

### DETAILED DESCRIPTION OF THE PREFERRED EMBODIMENTS

The following description of the preferred embodiment is merely exemplary in nature and is in no way intended to limit the invention, its application, or uses. For purposes of clarity, the same reference numbers are used throughout the drawings to identify similar components.

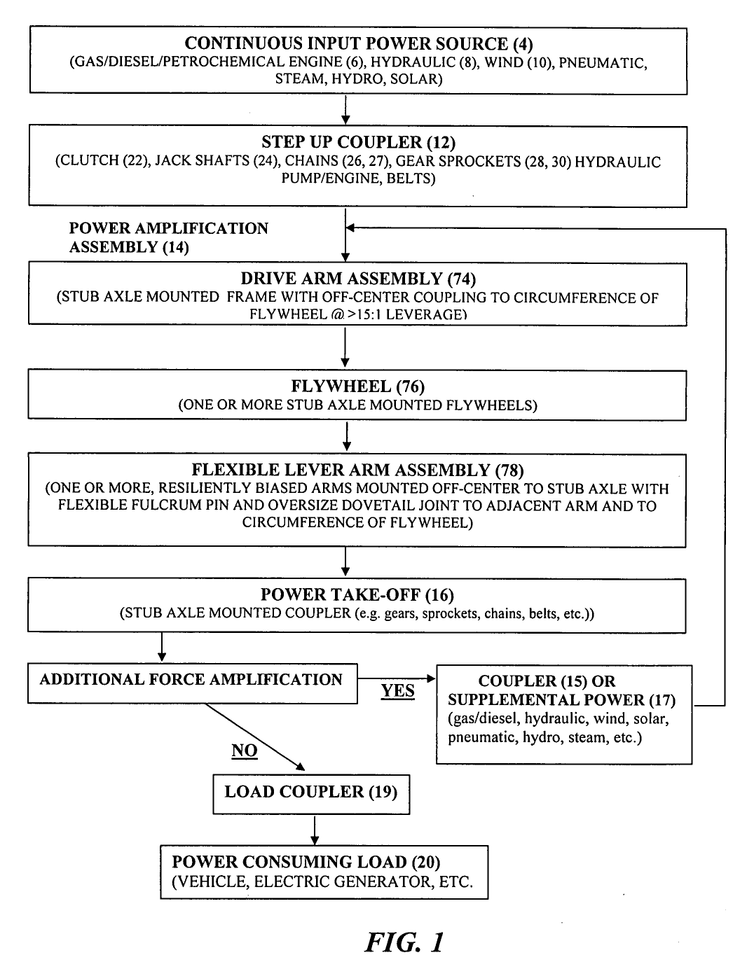

Referring to FIG. 1 a block diagram is shown to demonstrate the modularity of the invention and generalized application of the power transfer system 2 and the multiplication effects of the torque conversion/amplification assemblies 4 to supply power to a variety of power consuming loads and applications. Some typical loads that can be coupled to the output power of the system 2 are vehicles of all sizes and types, electric power generators or the like or any other load that requires a relatively small, energy and mechanically efficient power source.

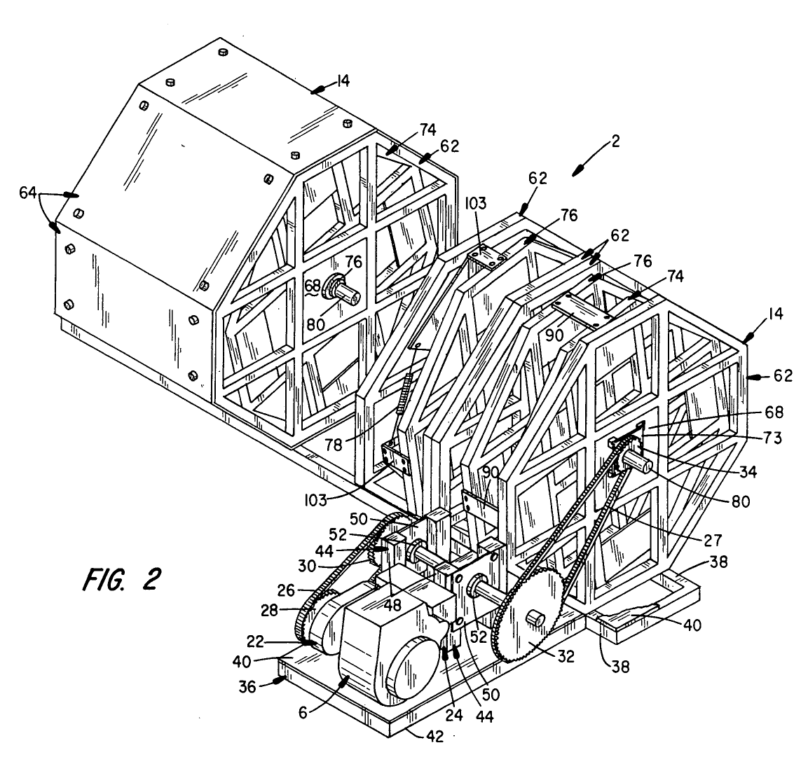

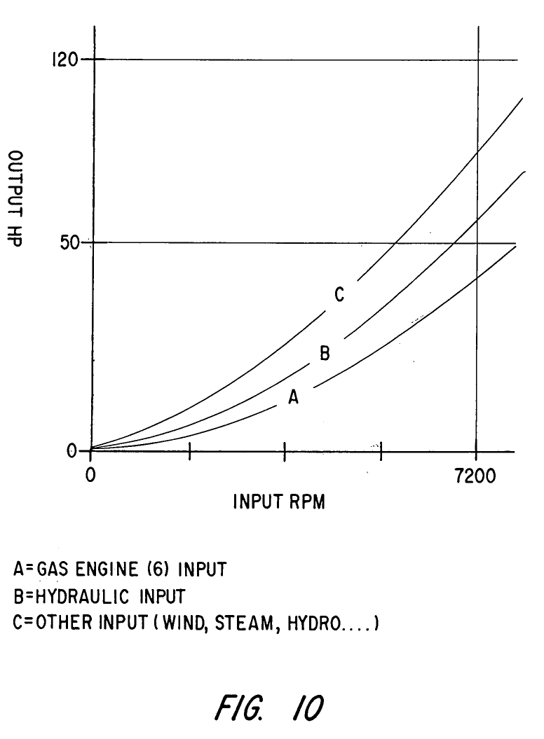

The system 2 is depicted in detail in relation to a presently preferred mechanical system assembly and constructions shown at FIGS. 2 through 8. The latter figures depict currently considered constructions and particular mechanical arrangements of assembled piece parts. A generalized alternative, multi-stage system configuration, wherein the stages and intermediate couplings can be varies as desired, is shown at FIG. 10.

The system 2 is supplied with a substantially continuous source of input power source 4 that is presently provided from exemplary gas, hydraulic and wind power input sources 6, 8 and 10. The input power source 4 interconnects with a step-up coupler 12 that supplies the power to a power (e.g. torque) conversion/amplification, transfer assembly 14.

The assembly 14 is configured in a modular framework that is adaptable to multi-stage configurations such that one power take-off member 16 (e.g. output shaft (18)) can be coupled to the input of a second or n^{th} stage of a multi-stage system, where n≧1. The sequential coupling of power conversion/amplification, transfer assemblies 14 progressively amplifies the available power to meet the anticipated load

Each successive stage can coupled directly with an appropriate coupler 15. Alternatively, an additional supplemental power source 17 (e.g. gas engine, hydraulic pump, wind turbine, hydro source etc.) can be adapted between the assemblies 14 to offset system throughput power losses to obtain a desired eventual power output. If additional stages are not required, an appropriate load coupler 19 interconnects the assembly 14 to a power consuming load 20. The load 20 can comprise any device or system that requires amplified drive power from an efficient input power source. Some present particularly considered loads are vehicles of all types which require high torque input power. To the extent modifications and/or improvements have been considered to the system components, they are mentioned as appropriate.

With the foregoing system configuration, the toque power supplied from the input power source is amplified via a leveraged/offset coupling to an associated flywheel and transferred per the following formula.

$$\frac{WF \times CF \times RPM ' s / sec \times ADVANTAGE}{TF ( 5252 )} = Output Horsepower$$

Where:
WF is (weight force of flywheel(s), drive and lever arms+force of engine in ft-lb/sec−operating losses);
CF is centrifugal force of flywheels, drive and lever arms (e.g. 3);
RPM's/sec as measured at input shaft 80;
ADVANTAGE is lever arm ratio determined from coupling distance from support axle to flywheel (e.g. 18.6); and
TORQUE FORMULA (TF)=5252

For the exemplary power transfer system 2 described below, the torque obtained from a nominal 8 hp engine 6 operating at 3600 rpm's is amplified by a factor of approximately 18 to provide an empirical or measured amplified output horsepower in excess of 50 hp to the load 20. The calculated or theoretical output power suggests the assembly 14 is capable of an amplification in excess of 100 hp, but physical measurements have not been made to confirm the computed values.

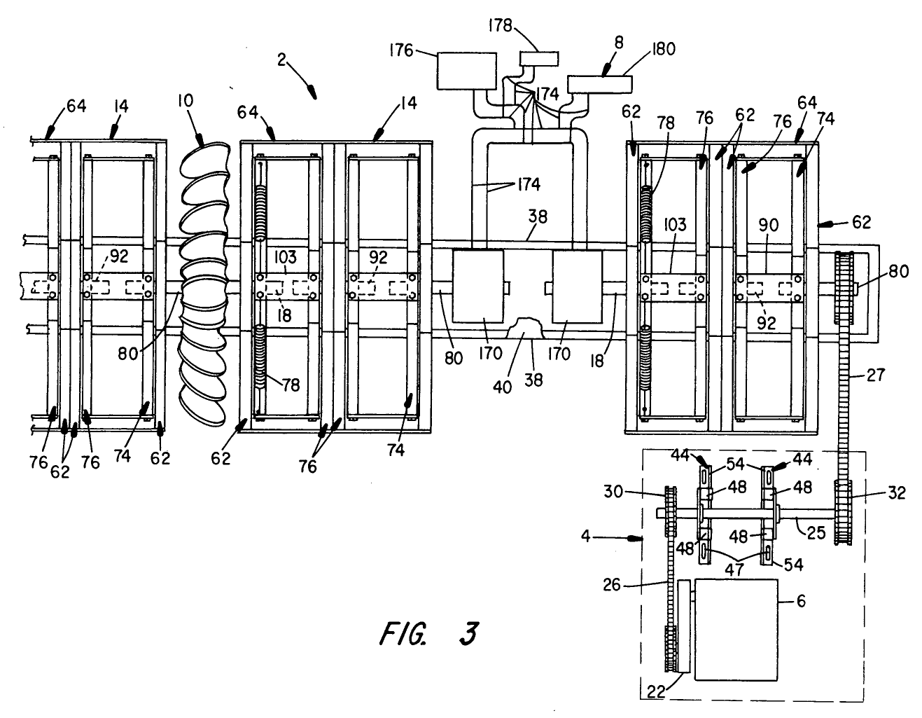

With reference to FIGS. 2 and 3, a gasoline engine 6 (e.g. 8 hp) presently supplies a source of continuous, rotational input power. The rotational power is supplied to a step-up coupler assembly 12 that includes a clutch 22, jack shaft assembly 24, chains 26 and 27 and sprocket sets 28, 30 (1:1) and 32, 34 (2:1) to the power amplification assembly 14. The amplification assembly 14 and associated stationary and rotating members is shown in detail at FIGS. 2 and 3 through 7.

The present 8 hp gasoline engine 6 provides a rotational output power on the order of 4400 ft-lb/sec at a rated rotational speed of 3600 rpm to coupler 12. The power is delivered via a conventional, offset clutch assembly 22 such as commonly used with snowmobiles. The output shaft 21 of the engine 6 mounts to the clutch 22. As centrifugal force develops, the clutch 22 engages an associated output shaft 25. The power is supplied from the shaft 25 to the sprocket 28 and via the chain 26 to the sprocket 30 fitted to a jack shaft 31 at the jack shaft assembly at a 1:1 ratio. Although the sprockets 28 and 30 are presently sized to be identical, they could exhibit different sizes and ratios. In lieu of chain/sprocket couplings it is to be appreciated belt/pulley or other appropriate step-up gear or shaft couplings could be used.

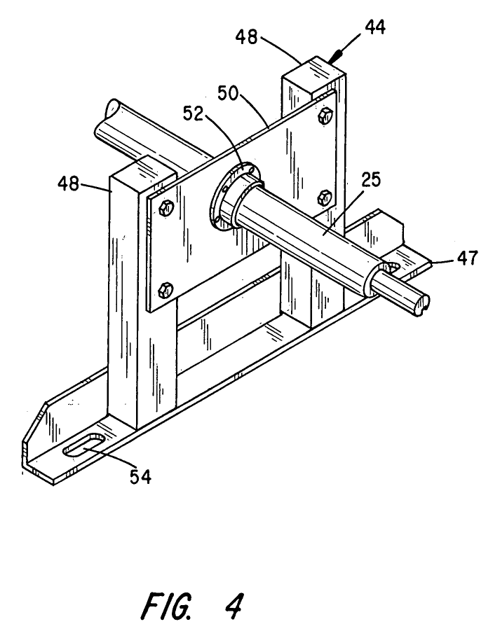

At the jack shaft assembly 24 which is shown in detail at FIG. 4, power is transferred via a jack shaft or stub axle 31 to the output sprocket 32 (e.g. 8″) and via chain 27 to the input sprocket 34 (e.g. 4″) to the power amplification assembly 14. The relative sizes of the sprockets 32, 34 provide a 2:1 ratio which increases the 3600 rpm's from the jack shaft assembly 24 to approximately 7200 rpm's at the input to the power amplification assembly 14.

To support system operation and assure proper alignment with minimal vibration of the rotating members at the amplification assembly 14, the components of the system 2 are mounted to a relatively heavy weight base frame 36. The frame 36 is constructed from longitudinal rail members 38 (e.g. 3½ tube stock) that exhibits a total length dependent upon the number of supported amplification assemblies 14 and intermediated supplemental power sources 17. The amplification assemblies 14 each extend approximately 20″ to 30″. The frameworks of the amplification assemblies 14 also presently exhibit an elongated octagonal shape having a diameter in the range of 28″ to 36″. Plates 40 (e.g. ½ flat steel) independently support and fasten the engine 6, jack plate assembly 24 and power amplification assemblies 14 to the rails 38. The engine 6 and jack shaft assembly 24 are presently mounted to a plate 40 secured to lateral offset rails 42 that couple to the longitudinal rails 38.

The support frame 36 weighs approximately four times the weight of the moving members of the amplification assembly 14 (e.g. presently on the order of 200 to 225 lbs) at the normally anticipated operating speeds. The relative construction of the framework 36 and related sizes of the assemblies 14, 24 and power source(s) 6, 17 can be varied as desired relative to the working power and throughput requirements of each system configuration 2.

The jack shaft assembly 24 includes a pair of displaced upright frames 44 that support the interconnected stub axle or jack shaft 31. The frames 44 each provide a base piece 47 (e.g. angle iron) and from which a pair of uprights 48 project and between which a bearing plate 50 is supported. Bearings 52 are fitted to the bearing plate 50 at each frame 44 and support the jack shaft 31. The ends of the jack shaft 31 are sized and fitted with slotted keyways to support the sprockets 30 and 32. Slots 54 or other alignment aids are formed at the base pieces 47 to facilitate alignment, fastening and tensioning of the chains 26 and 27 relative to the supporting sprockets 28-34 and support plates 40. Although one form of jack shaft assembly 24 is shown, it is to be appreciated the assembly 24 can be configured differently and provide other chain tensioning mechanisms and couplings to the rail framework 38.

With additional attention to FIGS. 3 through 8, the framework of the amplification assembly 14 is presently configured with an elongated octagonal shape. The shape can be varied as desired or necessary relative to the mounting and shapes of the associated flywheels and/or interconnecting couplers. For example and in lieu of the horizontally mounted members of the amplification assembly 14, the amplification assembly 14 may be mounted vertically to accommodate associated supplemental power sources or couplings.

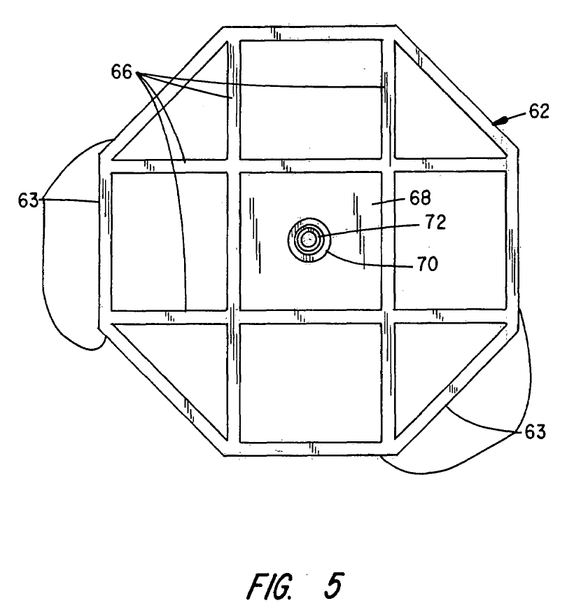

A support framework 60 provides several octogonal frame sections 62 shown in detail at FIG. 5. The frame sections 62 are horizontally separated and secured together with cover plates 64. The framework 60 presently consists of input and output end frames 62 and a pair of intermediate frame sections 62.

FIG. 5 depicts the construction of each end and intermediate frame section 62. Each frame section 62 includes frame pieces 63 that are arranged to form an octagonal shape, although again other frame shapes can be constructed (e.g. circular etc.). Parallel cross brace members 66 that project between opposite corners of the frame section 62. The bracing members 66 reinforce the frame sections 62 against the anticipated loading and stresses placed on the contained stub axles.

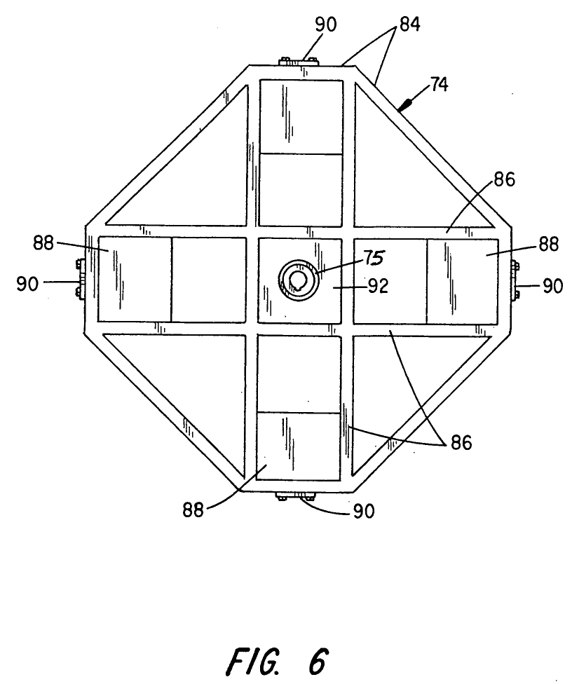

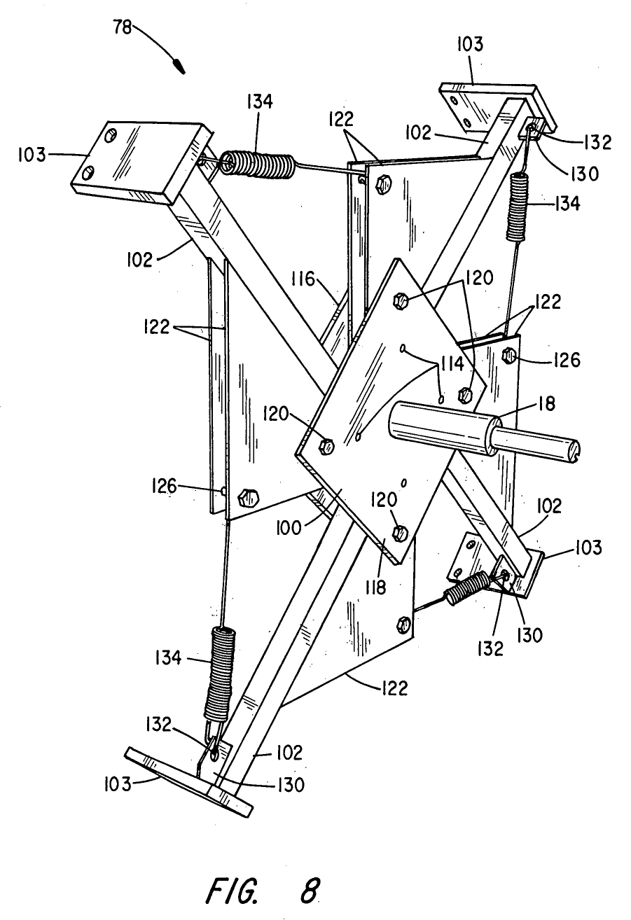

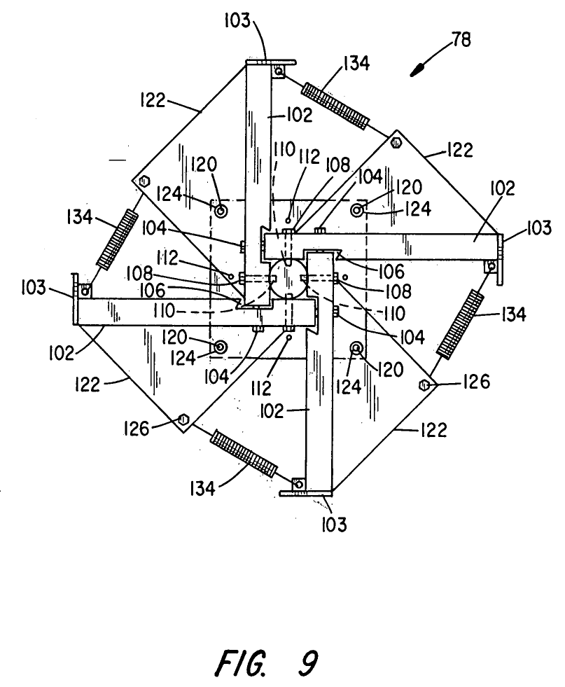

A plate 68 is secured to the members 66 at the center of the frame section 62. A recess 70 is formed into the plate 68 and an appropriately sized bearing 72 is press fit into the recess 70. The bearing 72 provides a tapered internal shaft support surface which centers the frame 62 to an associated axle shaft (e.g. 18, 80 or 92). Similar bearings 72 are used to couple a drive arm frame assembly 74 shown at FIG. 5, flywheels 76 shown at FIG. 6 and lever arm assembly 78 shown at FIGS. 8 and 9 to the stationary frame sections 62. The latter rotating frame assemblies 74, 76 and 78 are described more fully below. Offset pillow bearings 73 are also provided at the input and output end frame sections 62 to enhance the bearing surfaces of an input stub axle 80 and output stub axle 18 against loading. The axles 18, 80 and a flywheel support axle 92 are mounted to align along a common longitudinal axis, although the axles 18, 80 and 92 could be aligned along different axes depending upon the construction of the framework 60.

The input end frame 62 includes the input stub axle 80 that supports the sprocket 34 on one side of the frame 62 and supports a drive arm frame 82 on the opposite side of the end frame 62. The drive arm frame 74 is shown at FIG. 6, is keyed to the axle 80 with a tapered coupler 73 having a key and mating slotted keyway, and is mounted to rotate within the interior of the amplification assembly 14. The drive arm frame 74 is constructed to an elongated octagonal configuration that exhibits a reduced diameter to permit rotation within the space provided within the framework 60 and beneath the cover plates 64.

With attention to FIG. 6, the drive arm frame 74 is constructed from frame pieces 84 to exhibit a slightly elongated octagonal shape. The diameter of the frame 74 is sized to permit rotation within the framework 60. Cross brace members 86 extend parallel to each other between the corners of the frame 84. Weights 88 constructed from plate stock are secured at the outer periphery of the framework 82 between the brace members 86. The thickness and size of the weights 88 can be varied as desired. Projecting from the ends of the frame pieces 84 adjoining the weights 88 are arms 90 that bolt to the outer circumference of an adjoining input flywheel 76. Mounted to the center of the brace members 86 is a bearing plate 92 that supports a press fit, keyway containing coupler 75.

The input flywheel 76 is keyed to independently rotate on a stub axle 92 fitted to the bearings 72 of the adjoining intermediate frame sections 62. The stub axle 92 is supported from the pair of intermediate frame sections 62 to provide a wider bearing surface and accommodate the weight of the flywheels 76 and operating stresses.

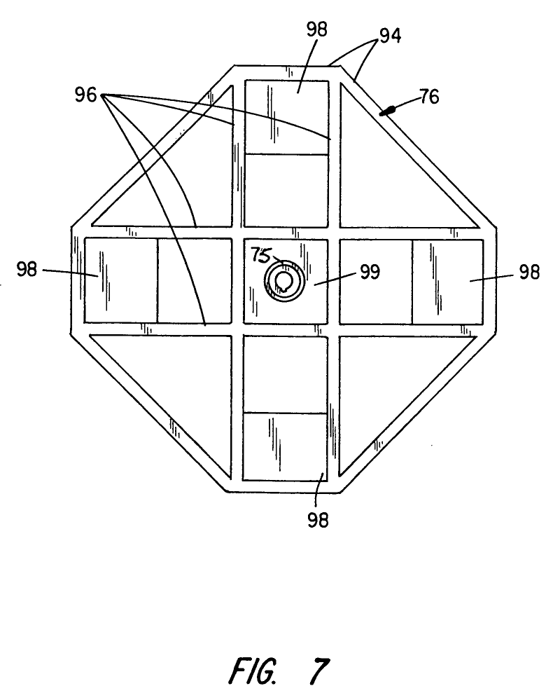

FIG. 7, depicts the construction of the input and output flywheels 76 that are presently provided at the amplification assembly 14. The flywheels 76 are mounted to rotate in unison via couplers 75 which permit the keying of the flywheels 76 to the stub axle 92 with keys fitted to the mating slotted keyways on opposite sides of the intermediate frame sections 62. Each flywheel 76 is generally constructed to a similar configuration as the drive arm frame 74, although the weight of each flywheel 76 can be varied as desired. Presently, the combination of the drive arm 74, lever arm assembly 78 and flywheels 76 exhibit a combined weight in the range of 200 lb to 225 lb.

Each flywheel 76 is particularly constructed from frame pieces 94 to exhibit a shape similar to the drive frame 74. Cross brace members 96 extend parallel to each other between the corners of the flywheel frame 76. Weights 98 constructed from plate stock are secured at the outer periphery of the framework 76 between the brace members 96. The thickness and size of the weights 98 can be varied as desired. Mounted to the center of the brace members 96 is a bearing plate 99 that supports a press fit keyed coupler 75 in a similar manner as at the drive frame 74.

Coupling the output flywheel 76 to the output stub axle shaft 18 is the flexible lever arm assembly 78 which is depicted in detail at FIGS. 8 and 9. FIG. 8 depicts a perspective view of the assembly 78 and FIG. 9 depicts a plan view with an end cover plate 100 and output stub axle shaft 18 removed. The assembly 78 provides several lever arms 102 that are arranged around the circumference of the stub axle 18. The arms 102 via end coupler plates 103 secure the assembly 78 to the output flywheel 76 and transfer the rotational power from the drive frame 74 and flywheels 76 to the output shaft 18.

The arms 102 are loosely coupled to each other with fasteners 104 threaded through each arm 102 to the end of an associated orthogonal arm 102. The fastened end of each arm 102 is recessed into a slot 106 with dovetail or other angled walls formed into a mating arm 102. The slots 106 are oversized to permit the arms 102 to project orthogonal to and pivot slightly within the slots 106. By recessing the ends of the arms 102 into each other the diameter of the supporting axle 92 can be reduced (e.g. turned down) in the region where the arms 102 are coupled to the axle 92, the effective length of the lever arms 102 is thereby advantageously increased to provide an effective lever arm ratio on the order of 18.6:1 for the present assembly which otherwise has a lever arm ratio on the order of 17:1 at the drive frame arm 74.

A fulcrum pin 108 mounted through the sides of each arm 102 is separately fastened to project from each arm 102 and loosely nest within an aperture 110 formed into the stub axle 18. Each fulcrum pin 108 is captured to an arm 102 and a separate retainer fastener 112 (e.g. cotter pin) is located to prevent the fulcrum pins 108 from dislodging. Cotter pins are presently used as the retainer fasteners 112 and mount through apertures 114 provided at inner and outer cover axle plates 116 and 118. A variety of other retainer fasteners can be used.

The cover plates 116 and 118 secure the lever arms 102 in a planar alignment and support the stub axle 18. The stub axle is welded to the inner cover plate 116 and keyed to a coupler 75 fitted to the outer cover plate 118 whereby lever arm assembly 78 rotates on axle 18 rotates within the bearing 72 of the output end frame 62. Fasteners 120 extend through oversized holes 124 formed in the parallel gusset braces 122 that are welded along the side of each arm 102. The fasteners 120 clamp the cover plates 116 and 118 to the arms 102 yet permit the arms 102 to pivot within the slots 106 and axle apertures 110 as the centrifugal force builds in the assembly 14.

Separately mounted between pin fasteners 126 that project between the gusset braces 122 and apertures 130 at tabs 132 at the coupler plates 103 are springs 134. The springs 134 resiliently bias the arms 102 and provide a slight enhancement of the rotational forces and output power of the assembly 114. The output power is enhanced by the tension stored in the springs 134 which stretch and pull the arms 102 with increasing centrifugal rotation of the arm assembly 78. The springs 134 and flexible mounting of the assembly 78 is further provided to compensate for slight misalignment and ensuing vibrations that may occur between the mountings of the stub axles 18, 92 and 80 and/or other portions of the assembly 14. In lieu of the depicted spiral wound springs other types and mountings of resilient, expansive/compressive biasing members can be mounted to the assembly 78 (e.g. elastomer members, leaf springs, coil springs etc.).

Returning attention to FIG. 3, the amplified output power is coupled from the first stage amplification assembly 14 to a second stage amplification assembly 14 via an intermediate hydraulic coupler assembly 8. The assembly 8 comprises a hydraulic pump 170 that is coupled to the output shaft 18 and a hydraulic engine 172 coupled to the input shaft axle 80 of the second stage power amplification assembly 14. Supporting the operation of the pump 170 and engine 172 via hydraulic fluid conduits 174 are a hydraulic fluid supply tank 176, filter 178 and flow control switch 180.

The second stage power amplification assembly 14 further amplifies the power developed by the system 2. The power can be further amplified by adding additional stages of power amplification assemblies 14. To compensate for inherent friction and power losses, supplemental power source 17 can be added at each coupling such as by coupling a supplemental engine to the hydraulic coupler 8 of via a wind turbine 10. The turbine 10 would typically be coupled to the output shaft 18 and may include additional necessary linkage assemblies to facilitate the coupling. A conventional coupler 15 (e.g. sleeve, gears, sprocket/chain, pulley/belt) may only be required under certain circumstances.

FIG. 10 depicts exemplary, generalized power transfer waveforms showing measured values of input RPM's from several types of possible input power sources 4 and anticipated output horsepower curves measured at the load coupler 19 for different types of input power sources. Applicant however does not presently have empirical, measured data, due to equipment failures at the measurement devices. Applicant has however confirmed the operation of the system 2 and an amplification of output power, but has not been able to obtain accurate readings of the amplification and power increase relative to calculated values derived from the foregoing formula.

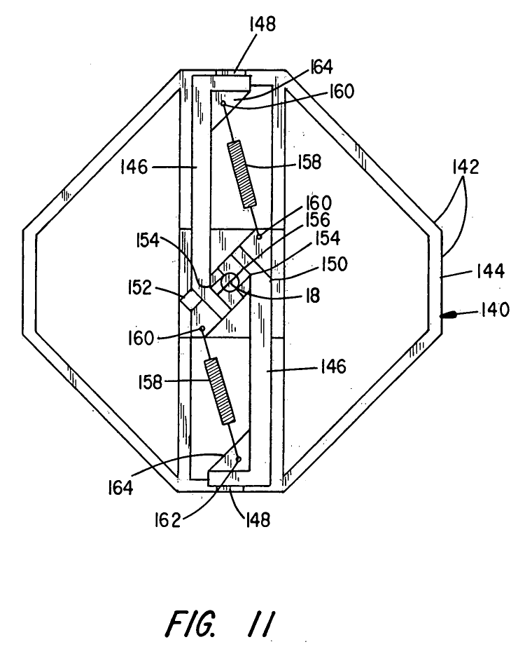

FIG. 11 depicts an alternative, frame-type lever arm assembly 140 that might be adapted to the assembly 14 in lieu of the multi-arm assembly 78 of FIGS. 8 and 9. The assembly 140 is constructed from frame pieces 142 that are arranged to form a lever arm framework 144 exhibiting an elongated octagonal shape similar to the drive and lever arm frames 74 and 76, although with fewer cross brace members. Extending between the frame pieces 142 are a pair of lever arm members 146. The arm members 146 are secured to the framework 144 at to the outer circumference of output flywheel 76 with coupler plates 148.

The arm members 146 are secured to the coupler plates 148 with appropriate threaded fasteners fitted through oversized apertures/slots formed in the plates 148. The arm members 146 are separately attached with a loose fitting to the central stub axle shaft 18, which rotates within the output bearing 72 of the output end frame 62.

The stub axle 18 projects from a bearing plate 150. A cover plate 152 (not shown) separately mounts over the plate 150. Fasteners 154 extend between the plates 150 and 152 and bushings (not shown) separate the arm members 146 from the plates 150 and 152 to permit a loose movement of the arm members 146 relative to the output axle 18 and plates 150 and 152 in a manner similar to the assembly 78. One or more fulcrum pins 156 extend between formed interior ends of the arm members 146 and into the output axle 18.

Resilient spring members 158 extend from pins 160 fitted to the plates 150 and 152 and to apertures 162 formed in end tabs 164 of the arm members 146. The arm members 146 are thus coupled to the framework 144 with a loose, resilient coupling which permits the arm members 146 to pivot slightly relative to a output axle 18. As before, the springs 158 and flexible mounting of the assembly 140 enhance the obtained power as the spring expands with centrifugal force and compensates for slight misalignment and ensuing vibrations that may occur between the mountings of the stub axles 18, 92 and 80 and/or other portions of the assembly 14.

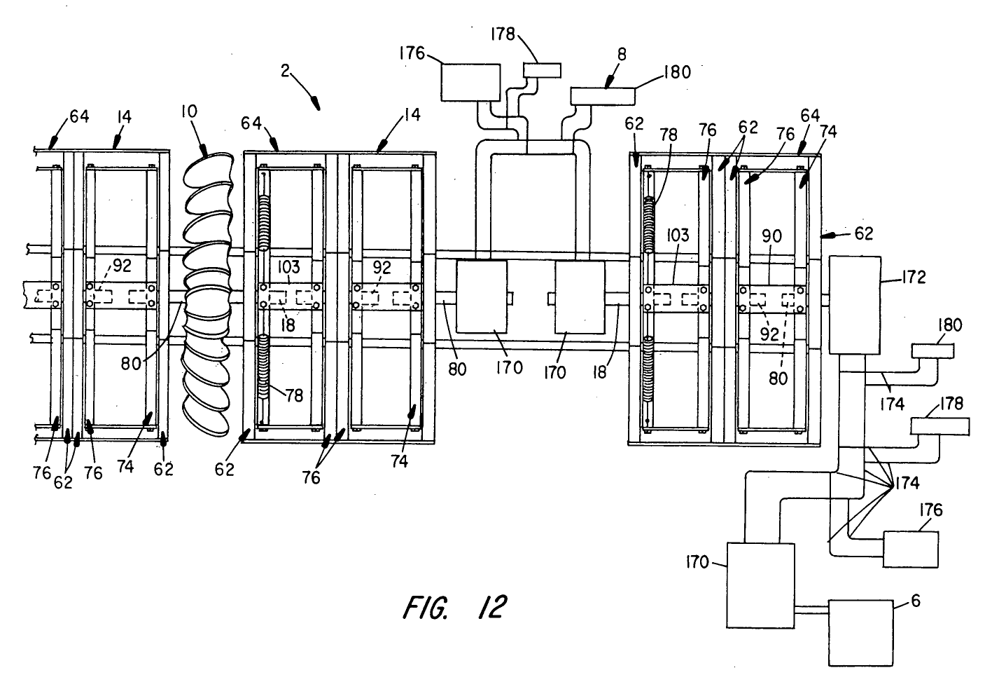

FIG. 12 lastly depicts an alternative, generalized system configuration similar to FIG. 3 but wherein a hydraulic engine 172 and pump 170 powered by a gas/diesel engine 6 supplies power to the input axle 80. The hydraulic engine 172 is able to develop greater input power versus the engine 6 and jack shaft coupler 24 of FIG. 3 to the amplification assembly 14 and thereby greater output power. A separate hydraulic pump/engine coupler assembly couples the first stage amplifier 14 to a second stage amplifier. The second stage output can again be coupled to directly to a desired load 20 or can be coupled to an exemplary wind turbine 10 that can again provide supplemental power to any successively following stages and intermediate couplings.

From the foregoing, it is to be appreciated the described construction of the power amplification assembly and depicted systems is merely exemplary of a presently considered assemblies and systems. From the suggested modifications and others that may be apparent to those skilled in the art, it also is to be appreciated the invention can be implemented in still other assembly and system configurations. For example, the power amplification assembly can be constructed with any number of flywheels or separately supported stages of flywheels with a variety of drive arm/frame and lever arm/frame constructions that couple to the flywheels at appropriate radial spacing(s) offset from the stub axle 18 to achieve desired mechanical advantages. The construction of the drive and lever arms/frames can be configured with more or less points of coupling to the flywheels. The construction of the lever arm/frames can provide for a flexible or inflexible coupling to a supporting axle member. The scope of the invention should therefore not be construed merely to the assemblies of the forgoing description, but rather should be construed within the broader scope of the following claims.

What is claimed is:

1. A power transfer assembly comprising:
a) an input power source;
b) a framework having a drive member supported to an input axle that is rotationally mounted to said framework, a flywheel member supported to a second axle that is rotationally mounted to said framework, and a lever arm member supported to an output axle that is rotationally mounted to said framework, wherein a first coupler mounts said drive member to said flywheel at a point displaced from said input and said second axles, wherein a second coupler mounts said lever arm member to said flywheel at a point displaced from said output and said second axles such that a lever arm advantage is obtained that amplifies the output power obtained at said output shaft;
c) a third coupler for coupling power from said input power source to said input axle; and
d) a fourth coupler for transferring power from said output axle to a load device.

2. An assembly as set forth in claim 1 wherein said input, second and output axles extend along a common axis.

3. An assembly as set forth in claim 1 wherein at least one of said drive member and said lever arm are secured to the circumferential periphery of said flywheel.

4. An assembly as set forth in claim 1 wherein said framework supports a plurality of displaced flywheel members mounted to rotate in unison at said second axle.

5. An assembly as set forth in claim 4 wherein said drive member is secured to the circumferential periphery of one of said flywheels and said lever arm is secured to the circumferential periphery of a displaced one of said flywheels.

6. An assembly as set forth claim 1 wherein said lever arm member comprises an assembly that includes a plate member that rigidly supports said output axle, a plurality of arm members each loosely mounted to radiate from said output axle at a fulcrum pin, and a plurality of compressive/expansive bias members mounted to resiliently bias each of said arm members, whereby each arm member can pivot to expand a coupled bias member when subjected to a centrifugal force.

7. An assembly as set forth in claim 6 wherein each arm member is coupled to a recessed slot formed into an adjacent arm member to accommodate a pivoting of each arm member upon experiencing a centrifugal force.

8. An assembly as set forth in claim 6 wherein each arm member includes a brace member secured along the length of the arm member and wherein said bias member comprises a spring mounted between said brace member and a distal end of said arm member.

9. An assembly as set forth in claim 1 wherein said drive arm member and said flywheel member are each configured as a framework comprised of a plurality of frame pieces, wherein a keyed coupler is centered within the framework, and wherein a plurality of weight members are symmetrically displaced about the framework.

10. An assembly as set forth in claim 1 wherein said lever arm member comprises a framework formed from a plurality of frame pieces, wherein said output axle projects from a plate, wherein a plurality of arm members are each loosely mounted to radiate from said output axle at a fulcrum pin, and wherein a plurality of compressive/expansive bias members are mounted to resiliently bias each of said arm members, whereby each arm member can pivot to expand a coupled bias member when subjected to a centrifugal force.

11. An assembly as set forth in claim 1 wherein said input power source comprises a petrochemical powered engine and wherein said third coupler comprises a linkage including a plurality of chains and sprockets mounted to increase the rpm's delivered to said input axle.

12. An assembly as set forth in claim 1 wherein said input power source comprises a petrochemical fuel powered engine and wherein said third coupler comprises a hydraulic linkage including a pump and a hydraulic engine.

13. An assembly as set forth in claim 1 wherein said load device comprises a second framework including drive and lever arm members coupled to the circumferential periphery of an intermediate flywheel and wherein said fourth coupler comprises a hydraulic linkage including a pump and a hydraulic engine.

13. An assembly as set forth in claim 1 wherein said load device comprises a second framework including drive and lever arm members coupled to the circumferential periphery of an intermediate flywheel and wherein said fourth coupler includes a linkage receiving power from a supplemental power source.

14. An assembly as set forth in claim 1 wherein said load device comprises a second framework including drive and lever arm members coupled to the circumferential periphery of an intermediate flywheel and wherein said fourth coupler comprises a wind turbine.

15. A power transfer assembly comprising:
a) an input power source;
b) a framework having a drive member supported to an input axle that is rotationally mounted to said framework, a plurality of displaced flywheel members supported to a second axle that is rotationally mounted to said framework and mounted to rotate in unison at said second axle, and a lever arm assembly supported to an output axle that is rotationally mounted to said framework, wherein said lever arm assembly comprises a plate member that rigidly supports said output axle, a plurality of arm members each loosely mounted to radiate from said output axle at a fulcrum pin, and a plurality of compressive/expansive bias members mounted to resiliently bias each of said arm members such that each arm member can pivot to expand a coupled bias member when subjected to a centrifugal force, wherein a first coupler mounts said drive member to the circumferential periphery of one of said flywheel members, wherein a plurality second couplers mounts each of said lever arms to the circumferential periphery of another of said flywheel members such that a lever arm advantage is obtained from the displaced coupling of said first and second couplers that amplifies the output power obtained at said output shaft;
c) a third coupler for coupling power from said input power source to said input axle; and
d) a fourth coupler for transferring power from said output axle to a load device.

16. An assembly as set forth in claim 15 wherein said load device comprises a second framework including a drive member and lever arm assembly coupled to the circumferential periphery of a second plurality of flywheels and wherein said fourth coupler comprises a hydraulic linkage including a hydraulic pump and a hydraulic engine.

17. An assembly as set forth in claim 15 wherein said input power source comprises a fuel powered engine and wherein said third coupler comprises a hydraulic linkage including a pump and a hydraulic engine.

18. A power transfer system comprising:
a) an input power source;
b) a first and second stage power amplification assemblies each having a drive member supported to an input axle that is rotationally mounted to a framework, a flywheel member supported to a second axle that is rotationally mounted to said framework, and a lever arm member supported to an output axle that is rotationally mounted to said framework, wherein a first coupler mounts said drive member to the circumferential periphery of said flywheel, wherein a second coupler mounts said lever arm member to the circumferential periphery of said flywheel such that a lever arm advantage is obtained from the displaced coupling of that amplifies the output power obtained at said output shaft;
c) a third coupler for coupling power from said input power source to said input axle of said first stage assembly;
d) a fourth coupler for transferring power from the output axle of said first stage assembly to the input axle of said second stage assembly; and
e) a fifth coupler for transferring power from the output axle of the second stage assembly to a load device.

19. An system as set forth in claim 18 wherein said first and second stage assemblies each comprise a drive member supported to an input axle that is rotationally mounted to a supporting framework, a plurality of displaced flywheel members supported to a second axle that is rotationally mounted to said framework and mounted to rotate in unison at said second axle, and a lever arm assembly supported to an output axle that is rotationally mounted to said framework, wherein said lever arm assembly comprises a plate member that rigidly supports said output axle, a plurality of arm members each loosely mounted to radiate from said output axle at a fulcrum pin, and a plurality of compressive/expansive bias members mounted to resiliently bias each of said arm members such that each arm member can pivot to expand a coupled bias member when subjected to a centrifugal force, wherein said input, output and second axles are aligned along a common axis, wherein a plurality of first couplers mount said drive member to the one of said flywheel members, and wherein a plurality second couplers mounts each of said lever arms to another said flywheel members.

20. An assembly as set forth in claim 20 wherein said input power source comprises a petrochemical fuel powered engine, wherein said third coupler comprises a hydraulic linkage including a pump and a hydraulic engine, and wherein said fourth coupler comprises a hydraulic linkage including a hydraulic pump and a hydraulic engine.
